(19) United States
(12) Patent Application Publication
(10) Pub. No.: US 2024/0343200 A1
(43) Pub. Date: Oct. 17, 2024

(54) AUTOMOTIVE VEHICLE FLOORING AND STORAGE SYSTEMS

(71) Applicant: Driverge Vehicle Innovations, LLC, Akron, OH (US)

(72) Inventors: Craig Kemmerling, Twinsburg, OH (US); Todd LaPant, Chico, CA (US); Phillip Austin, Cuyahoga Falls, OH (US)

(21) Appl. No.: 18/634,851

(22) Filed: Apr. 12, 2024

Related U.S. Application Data
(60) Provisional application No. 63/496,016, filed on Apr. 13, 2023.

(51) Int. Cl. B60R 7/04; B62D 25/20

(52) U.S. Cl. CPC B60R 7/04; B62D 25/20

(57) ABSTRACT

A system for converting a passenger vehicle is described. The system primarily comprises a flooring system configured to interface with vehicle body portions. The system may include openings that define storage spaces. Further, the system may accommodate existing vehicle features, thereby ensuring that vehicle systems, such as airbag systems, continue functioning properly.

This application claims the benefit of U.S. Provisional Patent Application Ser. No. 63/496,016, filed Apr. 13, 2023, the entire disclosure of which is incorporated by reference herein.

### FIELD OF THE INVENTION

Embodiments of the present invention are generally related to systems for converting a van.

### SUMMARY OF THE INVENTION

It is one aspect of some embodiments of the present invention to provide a system for leveling a cargo van floor.

It is another aspect of some embodiments of the present invention to provide a system for providing bulkheads in a cargo van that maintains the location and functionality of existing airbags.

It is still yet another aspect of some embodiments of the present invention to provide a system that effectively utilizes space previously allocated for seat storage while ensuring existing vehicle systems (e.g., airbag systems) remain functional.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112 (f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE DRAWINGS

The accompanying drawings, which are incorporated in and constitute a part of the specification, illustrate embodiments of the invention and, together with the general description of the invention given above and the detailed description of the drawings given below, serve to explain the principles of these inventions.

FIG. 1 is a partial cross section of a vehicle body showing a flooring system of one embodiment of the present invention.

FIG. 2 is a perspective view of a flooring system of one embodiment of the present invention.

FIG. 3 is a perspective view of the flooring system of FIG. 2, wherein doors have been removed.

FIG. 4 is a top plan view of the flooring system shown in FIG. 1.

FIG. 5 is a side elevation view of the flooring system shown in FIG. 1.

The following component list and associated numbering found in the drawings is provided to assist in the understanding of one embodiment of the present invention:

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

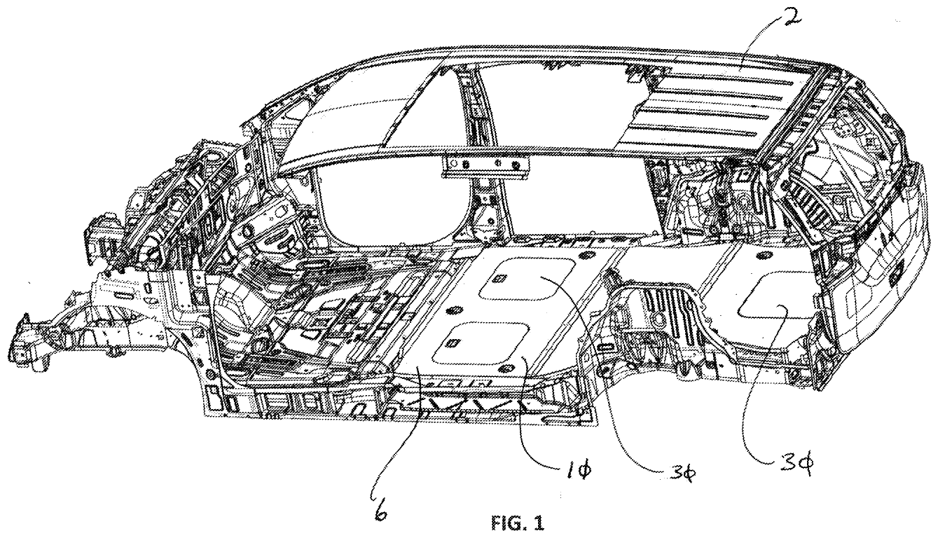

FIG. 1 is a partial cross section of vehicle body 2 that accommodates a flooring system 6 of one embodiment of the present invention. The flooring system 6 extends from about a midpoint of the vehicle body 2, towards the rear of the vehicle body, and is associated with a bottom portion of the vehicle body. One of ordinary skill in the art will appreciate that the flooring system can be integrated into other portions of the vehicle body without departing from the scope of the invention.

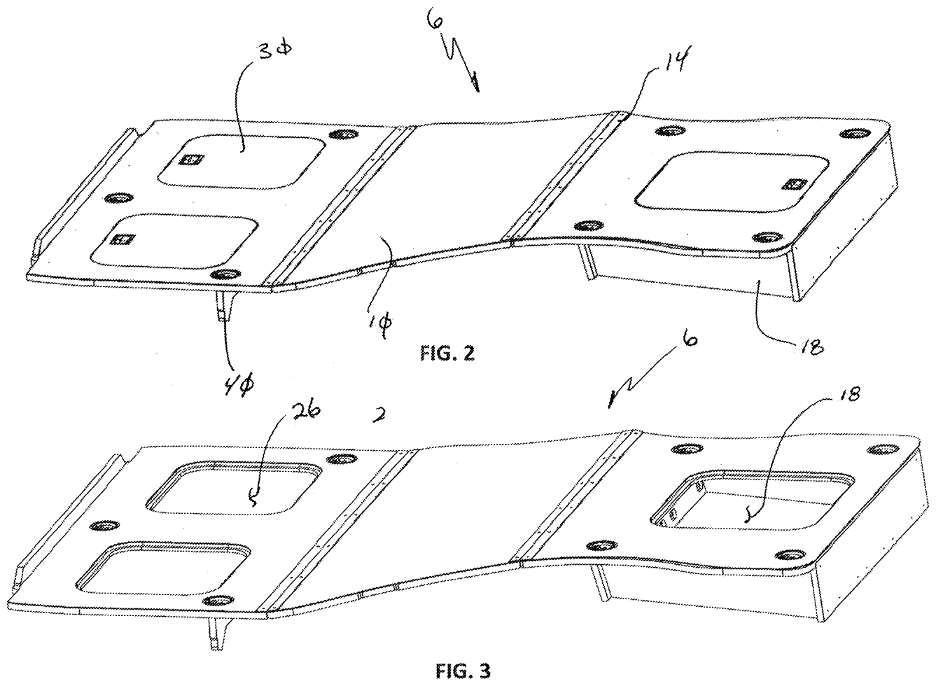

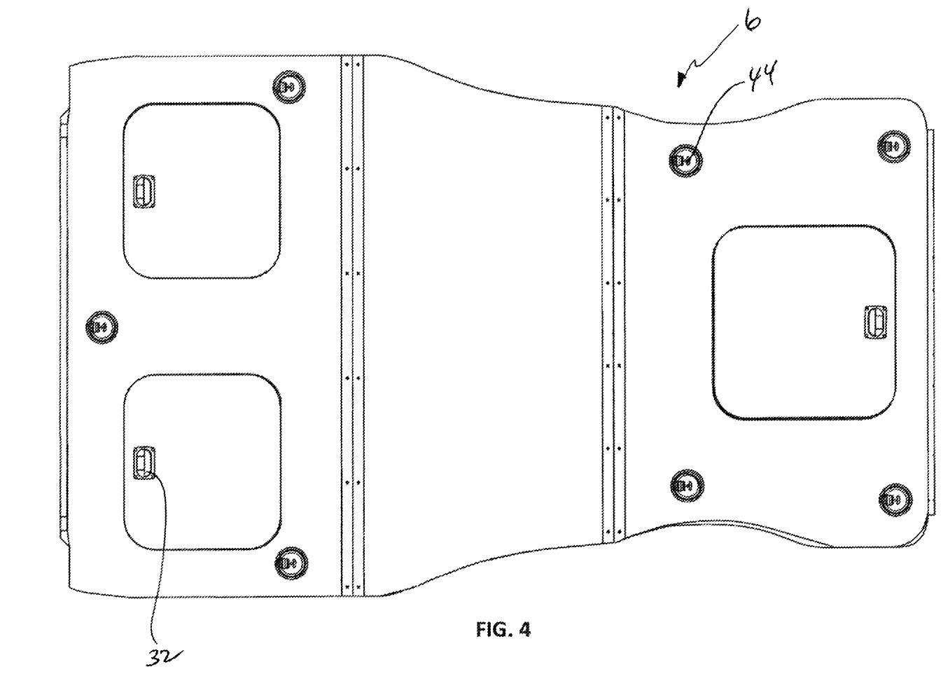

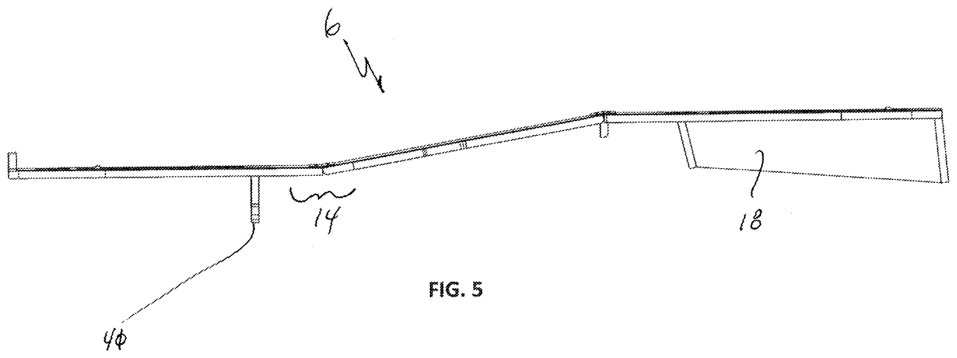

As also shown in FIGS. 2-5, the flooring system 6 comprises a plurality of panels 10 that may be selectively or operatively interconnected to each other. In the embodiment shown, the panels 10 are connected such that at least one transition 14 is provided to compensate for an uneven vehicle body 4 or to provide storage area 18 locations. At least one panel 10 has an opening 26 that may be selectively closed by a door 30 with a handle 32. The openings define storage areas 18 and volumes that may be comprised at least partially of vehicle body components. In operation, the panels are interconnected to the vehicle body by offsets 40, which include ends that interconnect to the vehicle body. The offsets of one embodiment of the present invention are selectively associated with fasteners 44 that allow for the panels to be removed if needed.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A flooring system configured to interconnect to a vehicle body floor, comprising:
a first panel;
a second panel operatively interconnected to the first panel;
an opening provided in at least one of the first panel or second panel;
a storage volume accessible through the opening, and defined at least partially by portions of the vehicle body.
